(19) United States
(12) Patent Application Publication
(10) Pub. No.: US 2002/0103977 A1
(43) Pub. Date: Aug. 1, 2002

(54) Low power consumption cache memory structure

(76) Inventor: Andy Ewoldt, San Jose, CA (US)

Correspondence Address: J.C. Patents, Inc., Suite 114, 1340 Reynolds Ave., Irvine, CA, 92614, US

(21) Appl. No.: 09/772,778

(22) Filed: Jan. 30, 2001

(51) Int. Cl. G06F 12/08

(52) U.S. Cl. 711/140; 711/118; 713/320

(57) ABSTRACT

The invention provides a low power consumption cache memory structure. In the present invention, the tag memory is accessed first and then the comparison is made. If there is a hit, only the correct bank of the array will be accessed, instead of all of the banks, thereby saving power. For example, if the array has four banks, then only one of the four banks will be read, saving the power required to read the other three banks. In addition, each array bank is divided into sub-banks called vertical banks. Each array bank is composed of cache lines, where each line stores several data words. Instead of powering up all of the lines in one array bank to read the desired data, only a subset of lines will be powered up, and each subset is a vertical bank. The vertical bank selection is made by decoding certain bits of the input address.

### BACKGROUND OF THE INVENTION

1. Field of Invention

The present invention relates to a memory structure, and more particularly, to a low power consumption cache memory structure.

2. Description of Related Art

The main memory in computer systems is frequently too slow to provide fast accessing by the central processing unit (CPU). Therefore, cache memories are used to allow the CPU to store data in an expedient manner. This provides the computer system with an overall higher performance and faster operating speed.

Refer to FIG. 1, which shows a block diagram of a conventional cache structure. The main components of the convention cache memory are the array memory 30, the tag memory 40, the comparators 50, and the multiplexor 60. The tag memory 40 stores the addresses of the data, while the data itself is stored in the array memory 30. The array memory 30 is broken down into banks. Each piece of data can be stored in only one location in each bank.

The tag memory 40 stores an address 10 for each location in each bank. To access a location, the cache will take an address 10 as an input, and this address 10 will be used to access the tag and read the addresses of the data stored at this location in the array memory 30. Next, the addresses of the data of each bank will be compared with the input address 10 to determine if the data is in the cache, and if so, which bank it is stored in. This comparison is done by the third main component, the comparators 50.

In a conventional cache structure, the tag memory 40 and the array memory 30 are accessed simultaneously, and after the tag is read, the addresses of the data stored in each array bank are compared to the input address to see if there is a hit. If there is a hit, the multiplexor 60 will select the correct array bank.

While cache memory has numerous advantages, cache memory consumes significantly more power than the standard main memory. Therefore, a cache memory with a reduced power consumption is desired.

### SUMMARY OF THE INVENTION

To achieve these and other advantages and in order to overcome the disadvantages of the conventional cache memory structure in accordance with the purpose of the invention as embodied and broadly described herein, the present invention provides a low power cache memory structure with a reduced power consumption.

In the present invention, the tag memory is accessed first and then the comparison is made. If there is a hit, only the correct bank of the array will be accessed, instead of all of the banks, thereby saving power. For example, if the array has four banks, then only one of the four banks will be read, saving the power required to read the other three banks.

In addition, each array bank is divided into sub-banks called vertical banks. Each array bank is composed of cache lines, where each line stores several data words. Instead of powering up all of the lines in one array bank to read the desired data, only a subset of lines will be powered up, and each subset is a vertical bank. The vertical bank selection is made by decoding certain bits of the input address.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 shows a block diagram of a conventional cache structure;

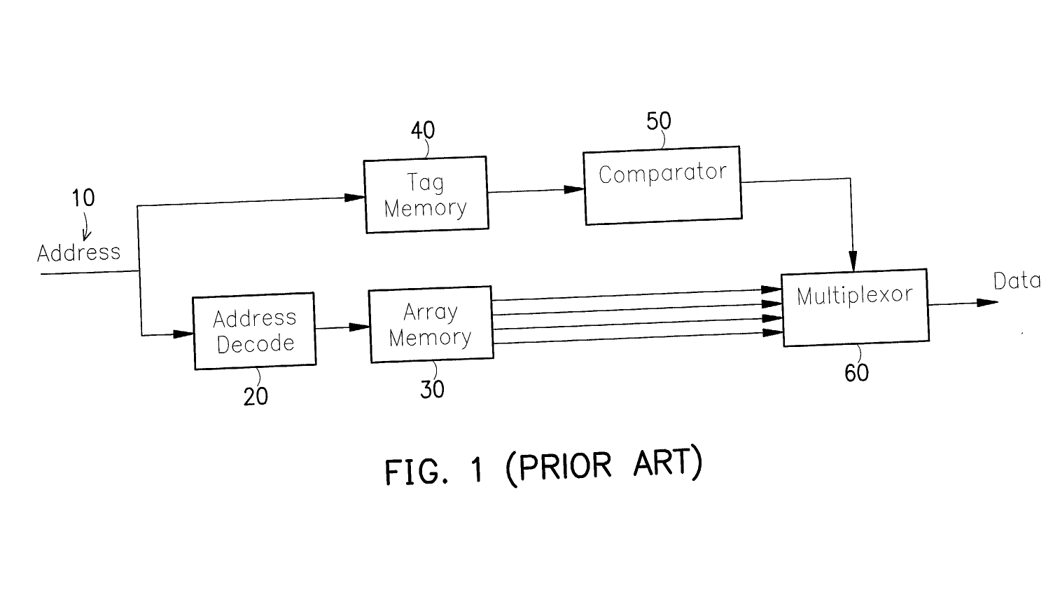

FIG. 2 shows a block diagram of a low power cache structure according to an embodiment of the present invention; and

FIG. 3 shows a block diagram of an array memory structure according to an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

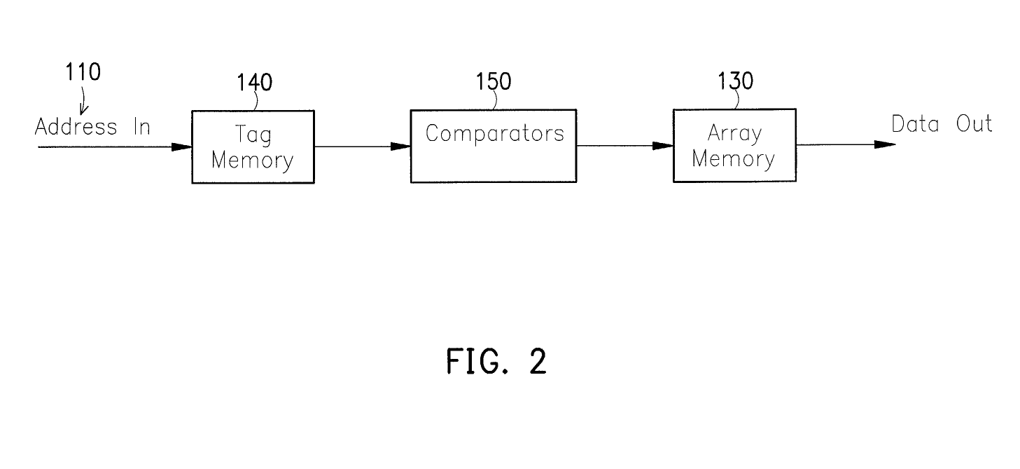

Refer to FIG. 2, which shows a block diagram of a low power cache structure according to an embodiment of the present invention;

In the present invention, the tag memory 140 is accessed first and then the comparison is made by the comparators 150. If there is a hit, only the correct bank of the array will be accessed in the array memory 130, instead of all of the banks, thereby saving power. For example, if the array memory 130 has four banks, then only one of the four banks will be read, saving the power required to read the other three banks.

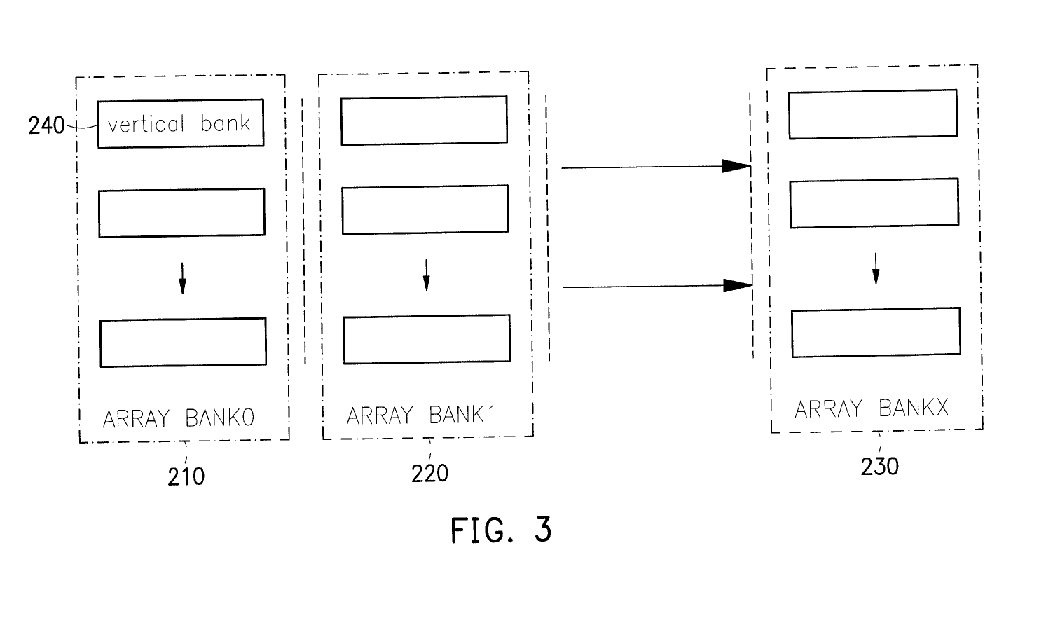

Refer to FIG. 3, which shows a block diagram of an array memory structure according to an embodiment of the present invention.

As was described, in an embodiment of the present invention only one of the banks in the array memory will be read. In addition, each array bank is divided into sub-banks called vertical banks. In FIG. 3, the array banks are illustrated as array bank 0 210, array bank 1 220, up to array bank x 230. Also shown in FIG. 3 is a vertical bank 240. Each array bank is composed of cache lines, where each line stores several data words. Instead of powering up all of the lines in one array bank to read the desired data, only a subset of lines will be powered up, and each subset is a vertical bank 240. The vertical bank 240 selection is made by decoding certain bits of the input address.

Therefore, since only the correct vertical bank containing the desired data is powered up, a significant reduction in power consumption is achieved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A low power consumption cache memory structure comprising:
an array memory for storing data and outputing the data;
a tag memory for receiving an input address and for storing addresses of the data stored in the array memory; and
a comparator for comparing the input address with the addresses stored in tag memory.

2. A low power consumption cache memory structure comprising:
an array memory for storing data;
a tag memory for receiving an input address and for storing addresses of the data stored in the array memory; and
a comparator for comparing the input address with the addresses stored in tag memory, wherein if the input address matches a stored address, the array memory will output data stored at the stored address.

3. A low power consumption cache memory structure comprising:
an array memory comprising:
a plurality of array banks for storing data;
a tag memory for receiving an input address and for storing addresses of the data stored in the array memory; and
a comparator for comparing the input address with addresses stored in tag memory, wherein if the input address matches a stored address, an appropriate array bank of the array memory will output data stored at the stored address.

4. The low power consumption cache memory structure of claim 3 wherein if the input address matches a stored address only the array bank with the matching stored address is powered up.

5. A low power consumption cache memory structure comprising:
an array memory comprising:
a plurality of array banks comprising:
a plurality of vertical banks for storing data;
a tag memory for receiving an input address and for storing addresses of the data stored in the vertical banks; and
a comparator for comparing the input address with addresses stored in tag memory, wherein if the input address matches a stored address, an appropriate vertical bank of the array memory will output data stored at the stored address.

6. The low power consumption cache memory structure of claim 5 wherein if the input address matches a stored address only the vertical bank with the matching stored address is powered up.

7. The low power consumption cache memory structure of claim 6 wherein the vertical bank is selected by decoding certain bits of the input address.

8. A low power consumption cache memory structure comprising:
an array memory comprising:
a plurality of array banks comprising:
a plurality of vertical banks comprising:
a plurality of cache lines for storing data;
a tag memory for receiving an input address and for storing addresses of the data stored in the cache lines; and
a comparator for comparing the input address with addresses stored in tag memory, wherein if the input address matches a stored address, an appropriate cache line of the array memory will output data stored at the stored address.
